(19) United States
(12) Patent Application Publication
(10) Pub. No.: US 2015/0353279 A1
(43) Pub. Date: Dec. 10, 2015

(54) Apparatus and Method for Opening a Container

(71) Applicant: Frederick Steven Azhocar, San Diego, CA (US)

(72) Inventor: Frederick Steven Azhocar, San Diego, CA (US)

(21) Appl. No.: 14/733,059

(22) Filed: Jun. 8, 2015

Related U.S. Application Data
(60) Provisional application No. 62/008,911, filed on Jun. 6, 2014.

(51) Int. Cl. B65F 1/14

(52) U.S. Cl. CPC B65F 1/1646

(57) ABSTRACT

The invention pertains to an apparatus and method for opening a lid of a trash container and maintaining the lid in an open position. The apparatus utilized is a securing tool having an elongate body with a lid receptacle and a rim receptacle. Extending from the rim receptacle is a slide extension and a wedge. A user places the slide under the lid of the trash container and slides the wedge section under the lid. The user then rotates the securing tool from a horizontal position to a vertical position, placing the lid fully within the lid receptacle. The user lifts the securing tool and places the rim of the base of the trash container within the rim receptacle. The securing tool keeps the lid in an open position so that the user may load items into the base of the trash container.

### PRIORITY

This application claims priority to U.S. Provisional Patent Application Ser. No. 62/008,911 filed on Jun. 6, 2014.

### FIELD OF THE INVENTION

This invention pertains generally to an apparatus for opening a container and maintaining a container in an open position. More specifically, the invention is directed toward a tool for lifting the cover of a trash container away from the base of the container and securing the cover in an open position to facilitate the placement of items in the base and the method of using the tool.

### BACKGROUND OF INVENTION

Taking out the trash has long been an undesirable and burdensome task. There are considerable inconveniences associated with the deposit of trash, garbage, refuse, waste, litter, rubbish, debris, junk, and the like, into a container. Typically, trash containers include a cover or lid disposed over the container opening for suppressing odors and/or preventing entry by animals. Larger containers, such as dumpsters, for example, may include a heavy hinged lid that may be difficult to lift and/or hold open. Often, one must open more than one container when removing waste from a home or business. For example, it is now typical for homeowners to have to open multiple different curbside collection bins for garbage, recyclable materials, and organic waste. Such curbside bins commonly include a hinged lid.

Others have attempted to address the nuisances attendant to depositing trash in a trash container in a number of different ways. In U.S. Pat. No. 2,862,683, a lid-lifting device for trash cans is provided wherein a lifting mechanism causes the lid to be lifted and swung out of the way by deployment of a foot pedal. While such a device allows for the lid to be displaced from the can in a “hands free” way, it is not suitable for use with larger trashcans having hinged lids that must be flipped up to access the inside of the trashcan. In U.S. Pat. No. 5,011,036, a front loading, foot operated refuse bin is disclosed, wherein the lid lifting feature is integrated into the trashcan design. The refuse bin includes a lid rotatably mounted to the rear portion of the side wall of the bin, a support device, a push rod, a swing arm pivotally secured to the side wall, and a pedal. In U.S. Pat. No. 5,704,511, a trash container adapted to hold a removable trash bag is provided and includes an outer frame with a hinged lid as well as a lid-lifting mechanism housed within the container. U.S. D583120 provides a bin lifter that is separate from the trash container. Presumably, a trash container can be placed in communication with the bin lifter, which also operates by deployment of a foot pedal.

In recent years, the problem of lifting a trash lid without getting your hands dirty has been solved by developing trashcans with power operated lids. Such trashcans can include a sensor positioned on or near the lid, which is configured to detect movement, such as a user's hand being waived near the sensor as a signal for opening the lid. When such a sensor is activated, a motor within the trashcan opens the lid or door and thus allows a user to place items into the trashcan and the lid can be automatically closed. Thus far, however, such designs have not been employed for use with larger sized trashcans such as the automated refuse collection containers mandated for use in certain municipalities wherein automated collection occurs. Further, the costs of such a trash container may be prohibitively expensive for large scale deployment by municipalities.

Thus, there remains a need for tools to facilitate the disposal of items in a trashcan to address the annoyance of struggling with a lid as well as reducing a user's physical contact with the trashcan.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a method for opening and securing a trash can lid in an open position with a securing tool. The securing tool comprises an elongate body having a first end and second end. The first end comprises the grip area disposed adjacent to a pair of substantially parallel protrusions from the first end, the pair of substantially parallel protrusions defining a rim receptacle. The second end comprises a pair of substantially parallel protrusions defining a lid receptacle. One of the substantially parallel protrusions defining the lid receptacle comprises a wedge section adjacent to the elongate body, the wedge section tapering to a slide section. The method comprises grasping a securing tool at a grip area, engaging the underside of a lid of a of a trash container with the slide section of the lid receptacle of the securing tool, sliding the slide section fully underneath the lid of the trash container, engaging the underside of the lid with the wedge section of the lid receptacle of the securing tool, applying a rotational force to the securing tool, pivoting the wedge further underneath the lid and lifting the lid upwards and away from the base of the trash container, applying a vertical force upward on the lid with the securing tool, placing the rim receptacle of the securing tool over the rim of the base of the trash container, disposing the rim of the base of the trash container between the pair of substantially parallel protrusions of the rim receptacle, and releasing the grip area of the securing tool, causing the securing tool to maintain the lid of the trash container to remain in a vertical position.

The method as in claim further comprises regrasping the grip area of the securing tool, applying a vertical force upward on the lid with the securing tool, removing the rim from the rim receptacle of the securing tool, lowering the securing tool, placing the lid on the rim of the base of the trash container, and removing the wedge section and the slide section of the securing tool from underneath of the lid of the trash container.

In another embodiment of the invention the securing tool further comprises a hook extending from the elongate body of the securing tool and the method further comprises hanging the securing tool on the side of the trash container with the hook when the securing tool is not in use.

In another embodiment of the invention the securing tool further comprises an opening in the elongate body of the securing tool and the method further comprising hanging the securing tool on a protrusion extending from the side of the trash container by placing the protrusion within the opening of the securing tool when the securing tool is not in use.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a top view of a lifting and securing apparatus according to one embodiment;

FIG. 2 is a side view thereof;

FIG. 3 is a perspective view thereof;

FIG. 4 is a side view of an illustration of the method of using the lifting and securing apparatus;

FIG. 5 is a side view of an illustration of the method of using the lifting and securing apparatus; and

FIG. 6 is a side view of an illustration of the method of using the lifting and securing apparatus.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

Covered trash bins must be opened before waste is inserted into the base. Often, one must flip open a lid with one hand while negotiating the placement of trash into the base. For certain types of containers, one must remove a cover and place the cover on an adjacent support or on the ground. These steps are inconvenient and cumbersome, especially in view of the fact that in many instances, large loads may require holding the waste with two hands. Moreover, trash containers are typically dirty, unhygienic, and unpleasant to touch. Thus, it may be necessary in these circumstances to first place the trash on the ground and then remove the lid, after which the trash may be picked up and deposited in the container. After the waste is deposited into the container, the lid must be returned to its closed position.

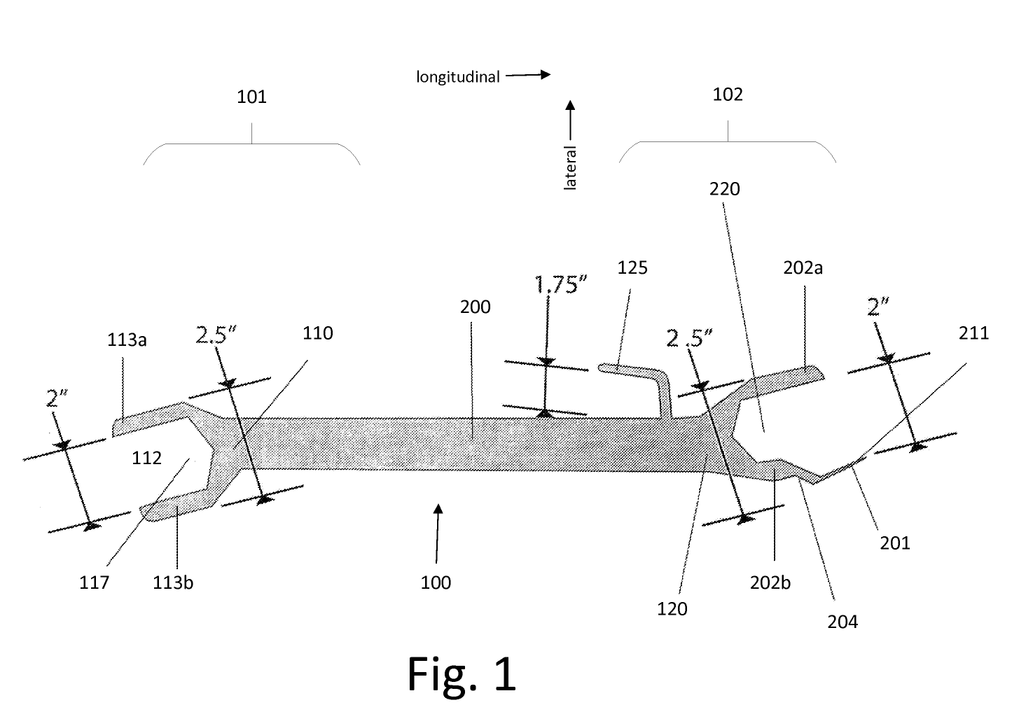

To assist in the description of these components of the device, the following coordinate terms are used. A “longitudinal axis” is generally parallel to the length of the elongated tool. A “lateral axis” is normal to the longitudinal axis and extends along the width of the tool. A “transverse axis” extends normal to both the longitudinal and lateral axes and extends along the depth of the tool. In addition, as used herein, “the longitudinal direction” refers to a direction substantially parallel to the longitudinal axis; “the lateral direction” refers to a direction substantially parallel to the lateral axis; and “the transverse direction” refers to a direction substantially parallel to the transverse axis. Also, the terms “proximal” and “distal,” are used to describe the tool and are used consistently with the description of the exemplary applications (i.e., the illustrative examples of the use applications). Throughout this description, the portion of the tool to the left as shown in FIG. 1 will be referred to as the proximal portion while the portion of the tool to the right will be referred to as the distal portion. The terms “upper,” “lower,” “top,” “bottom,” “underside,” “upperside” and the like, which also are used to describe the tool, are used in reference to the illustrated orientation of the embodiment being described.

Brief introductions to some of the features, which are common to the described embodiments of the apparatus are now described. The apparatus disclosed herein is especially adapted to facilitate the opening of a container having a hinged lid. Specifically, the apparatus provides a user a hand-held tool that may abut against one or more surfaces of the lid to facilitate opening. In some embodiments, the hand-held tool may be used to slide under a portion of the lid or be inserted between the lid and the rim defining the container opening. In general, such containers include a lid placed on a base. Often, the lid and/or base will include one or more surface features, such as a lip, handle, overhang, or indenture that the tool may contact. As such, a user may grip a proximal portion of the tool and engage the distal portion of the tool with a surface feature of the lid and/or base. In this way, a user need not contact the lid with their hands. In some embodiments, the tool includes a proximal gripping surface to help ensure that the tool does not slip or move about in the user's hand.

After the tool engages a portion of the lid, the user may provide an upward force so as to lift the lid away from the base. In some embodiments, the tool includes a wedge located towards the distal end of the tool. The wedge may be used to increase the distance of the lid from the base to initiate the opening process. At least a portion of the tool may then be placed under or against a surface of the lid, supporting the lid from below. In some embodiments, the distal portion of the tool may be shaped to receive at least a portion of the lid. For example, the distal portion of the tool may be shaped substantially complimentary to the shape of a cross-sectional portion of the lid. That is to say, the distal portion may be shaped such that the tool engages multiple surfaces of the lid. For example, the distal portion may be shaped and dimensioned such that the distal portion contacts one or more of an upper surface, a lower surface, and/or a front surface of the lid. In this way, the distal portion of the tool may more securely engage the lid.

After the distal end of the tool is engaged with the lid, the proximal portion of the tool may be placed on a top surface of the base. Thus, the lid may be propped open and/or secured in the open position when the proximal end is engaged with a portion of the base and the distal portion is engaged with a portion of the lid. Similar to the distal portion, the proximal portion of the tool may be shaped to receive one or more surfaces of the base. For example, the proximal portion may be shaped and dimensioned to receive one or more of an inner surface, an outer surface, and/or a top surface of the rim and/or base. In this way, the tool may securely engage the lid and the base, thus providing a stable and secure connection between the lid and the base and maintaining the hinged lid in an open position. In some embodiments, the tool is configured to be used with hinged curbside containers as generally shown and described in, for example, U.S. Pat. Nos. 7,100,791, 4,749,101, 5,323,923, and/or 5,150,806.

Various aspects will now be described with reference to specific forms and embodiments selected for the purposes of illustration and set forth in FIGS. 1-3. It will be appreciated that the spirit and scope of the tool illustrated below is not limited to this selected embodiment. While some of the illustrated embodiments include dimensions, the invention is not limited to these dimensions and various modifications may be made. The illustrated embodiments are not drawn to proportion or to scale. One of skill in the art will appreciate that many variations can be made to the illustrated embodiments.

FIGS. 1-3 illustrate a lifting and securing apparatus according to one embodiment. The length of the tool may be any suitable length that allows for the tool to prop open a hinged container. In one embodiment, the apparatus has a length of about thirty-three inches. As shown, the tool 100 comprises an elongated handle 200 having a proximal portion 101 and a distal portion 102. In general, the proximal portion 101 includes a proximal end 110 configured to engage a portion of a base of a container. The distal portion 102 includes a distal end 120 configured to engage a portion of a lid of the container. However, in some embodiments, the proximal end 110 is configured to engage a portion of the lid and the distal end 120 is configured to engage a portion of the base.

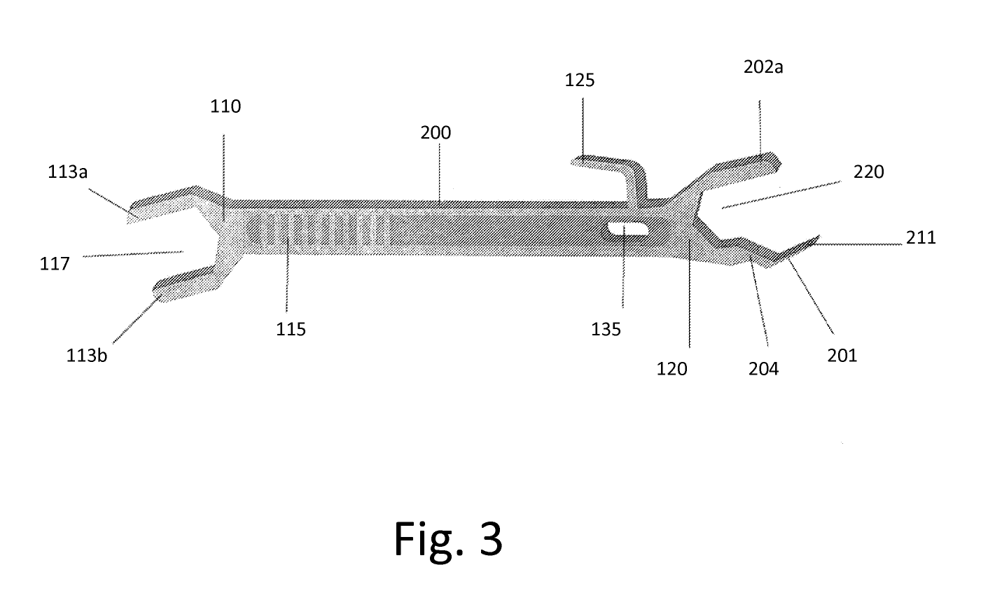

As shown in FIG. 3, the proximal portion 101 of the handle 200 may include a grip 115 disposed on one or more surfaces of the handle 200. The grip 115 may include, for example, raised protrusions, textured materials, high-friction surfaces, or other structures and/or materials known in the art for increasing the grip of a handle.

As shown in FIGS. 1 and 3, the proximal end 110 generally includes a “C” shaped portion 112. The “C” shaped portion 112 may include two protruding and substantially parallel projections 113a and 113b defining a rim receptacle 117 between the projections 113a and 113b and the proximal end of the handle 200. The rim receptacle 117 may be shaped to engage multiple surfaces of a base of a container, and in particular, may be shaped to engage one or more front, back, and/or side surfaces of the base. In particular, the rim receptacle 117 may be configured to receive the rim of a container that defines the container opening into which refuse is placed. The rim receptacle 117 may be shaped to fit a majority of curbside containers having hinged lids. In some embodiments, the rim receptacle 117 is shaped to fit more than one container.

In some embodiments, when engaged with the base, one or more surfaces within the “C” shaped portion 112 may contact and/or abut against the base. Thus, when the proximal end 110 is engaged with the base, the tool 100 may be prevented from moving in one or more of the longitudinal, lateral, and transverse direction. As shown best in FIG. 3, the “C” shaped portion 112 includes substantially flat surfaces along the transverse direction. However, these surfaces may be curved to help prevent the rim receptacle 117 from sliding when placed in contact with the base. In some embodiments, the rim receptacle 117 includes higher friction surfaces. For example, the rim receptacle 117 may include rubber surfaces.

Continuing with FIGS. 1-3, the “C” shaped portion 112 may be positioned at an angle with respect to the handle 200. The angle may be any suitable angle. For example, the “C” shaped portion 112 may be positioned at an angle of 10, 15, 20, 15, 20, 25, 30, 35, 40, 45 degrees, or more with respect to the handle 200. Having the “C” shaped portion 112 positioned at an angle with respect to the handle 200 may allow, for example, the tool 100 to extend away from the base at an angle when the “C” shaped portion 112 is positioned substantially normal to the top side of the rim defining the container opening. In this way, the handle 200 may extend upward at an angle such that the distal end of the tool may be placed in contact with the lid.

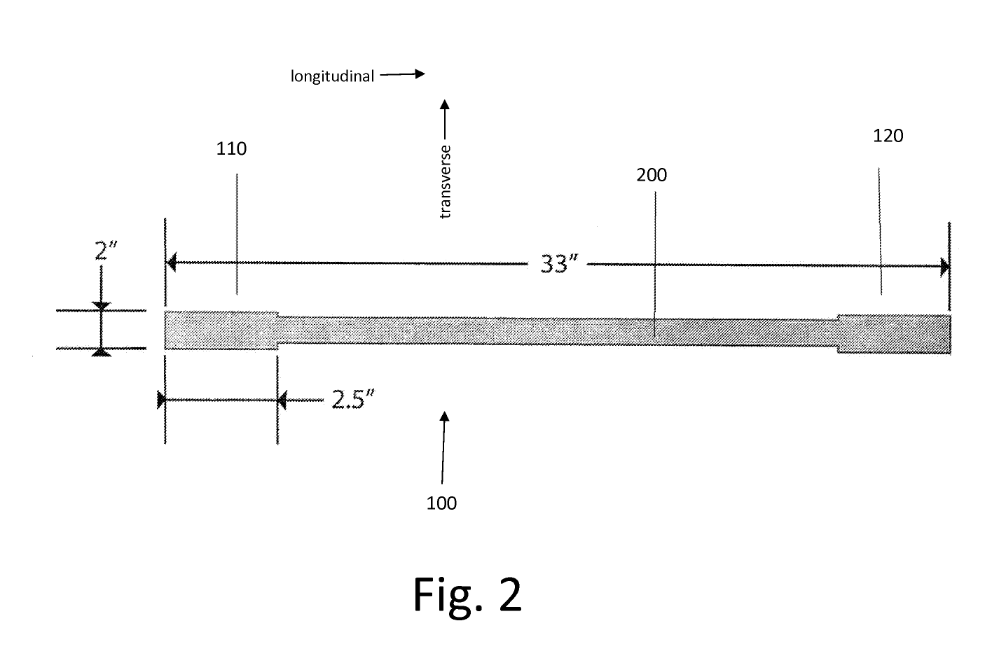

Turning to the distal portion 102 of the tool 100, the distal portion 102 may include a distal end 120 configured to engage with one or more surfaces of the lid. As shown in FIGS. 1-2, the distal portion 102 may also include a hook 125. In some embodiments, the tool 100 does not include a hook 125. In other embodiments, the tool 100 includes more than one hook 125. The hook 125 may be used to store the tool 100. For example, the tool 100 may be stored by securing the hook 125 to a surface feature of a container. Alternatively and/or additionally, the tool 100 may include one or more openings, for example opening 135 as shown in FIG. 3, to reduce the weight of the tool 100 and/or to provide a means for hanging the tool 100 on a hook or nail when storing the tool 100.

The distal end 120 of the tool 100 includes a lid receptacle 220. This distal lid receptacle 220 is configured to contact and/or abut against one or more surfaces of the lid. For example, the lid receptacle 220 may be shaped to engage multiple surfaces of the lid and in particular, may be shaped to engage one or more front, back, and/or side surfaces of the lid. In some embodiments, the lid receptacle 220 is sized and shaped such that it contacts at least the bottom surface of the lid and a top surface of the lid. In some embodiments, the lid receptacle 220 is shaped so that it is substantially complimentary to the shape of a cross-sectional portion of the lid. When the lid receptacle 220 is engaged with the lid, the lid and/or tool 100 may be prevented from moving in one or more of the longitudinal, lateral, and transverse direction. In the embodiment illustrated the distal end 120 of the tool has two protruding and substantially parallel projections 202a and 202b defining a lid receptacle 220 between the projections 202a and 202b and the distal end of the handle 200.

The distal end 120 of the tool 100 may also include a slide 201. The slide 201 may comprise a relatively thin projection configured to be insertable and/or slidable between the base and the lid. The slide 201 may include a first surface 211 for contacting the undersurface of a lid. In some embodiments, the slide 201 may increase in transverse thickness along a direction from the distal end to the proximal end. In this way, as the slide 201 is inserted between the lid and the base, the distance between the lid and the base increases. In some embodiments, the slide 201 terminates in a wedge 204. The wedge 204 may help to further increase the distance between the lid and the base. The wedge 204 may have a transverse thickness that is greater that the transverse thickness of the slide 201. The wedge 204 may also serve as a pivot point that may abut against the lid and facilitate the one or more surfaces of the lid into the lid receptacle 220. Similar to the rim receptacle 117, lid receptacle 220 may include one or more transverse surfaces that are curved and/or have higher friction surfaces to help prevent the lid receptacle 220 from sliding when placed in contact with the lid.

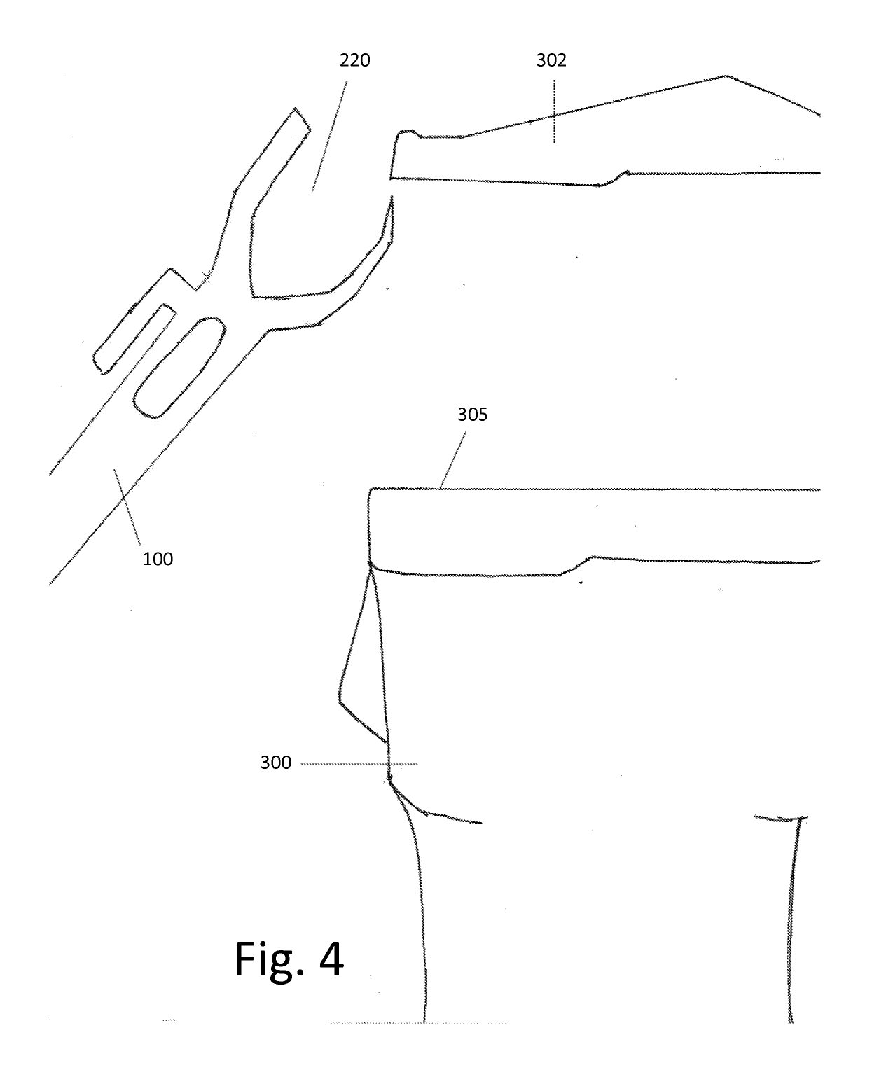

With reference now to FIGS. 4-6, a schematic illustration showing a method of using the apparatus of FIG. 1 according to one embodiment is depicted. As schematically shown in FIG. 4, the lid receptacle 220 may be slid between the lid 302 and the base 300. After the lid receptacle 220 is slid between the lid 302 and the base 300 a user may rotate the tool towards the base 300 and/or provide an upward force to separate the lid 302 from the base 300.

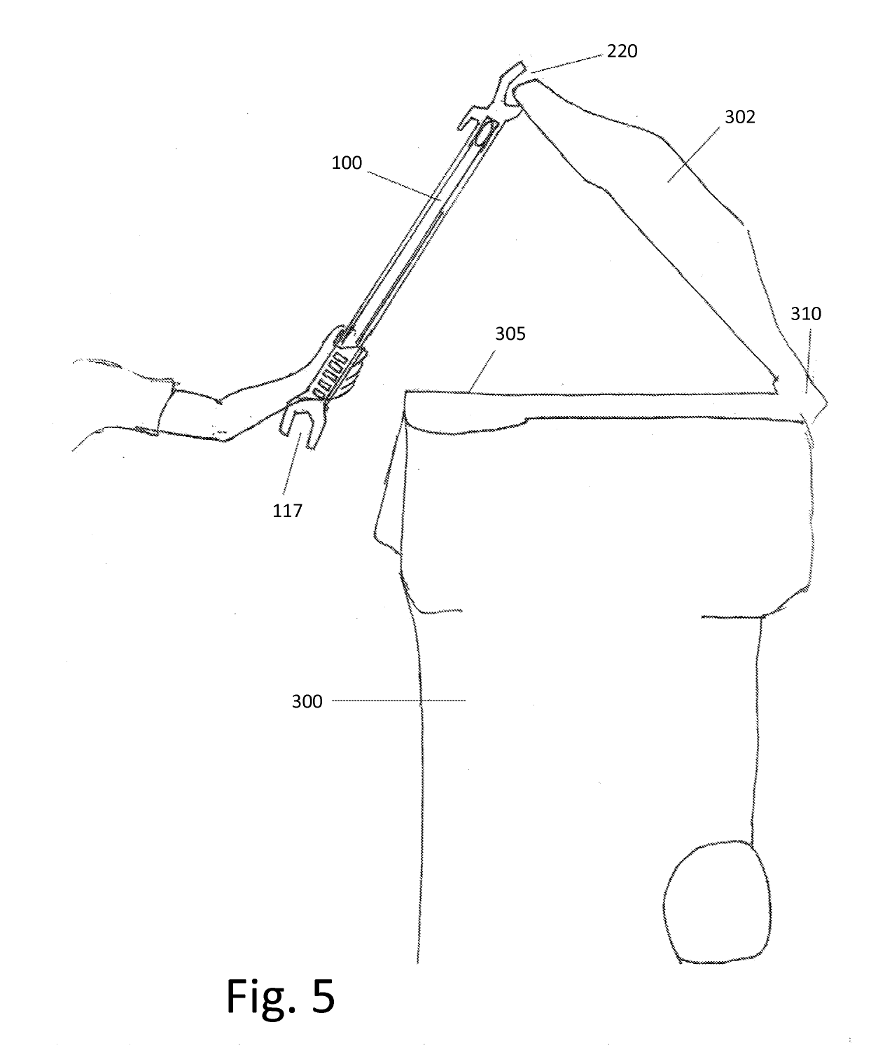

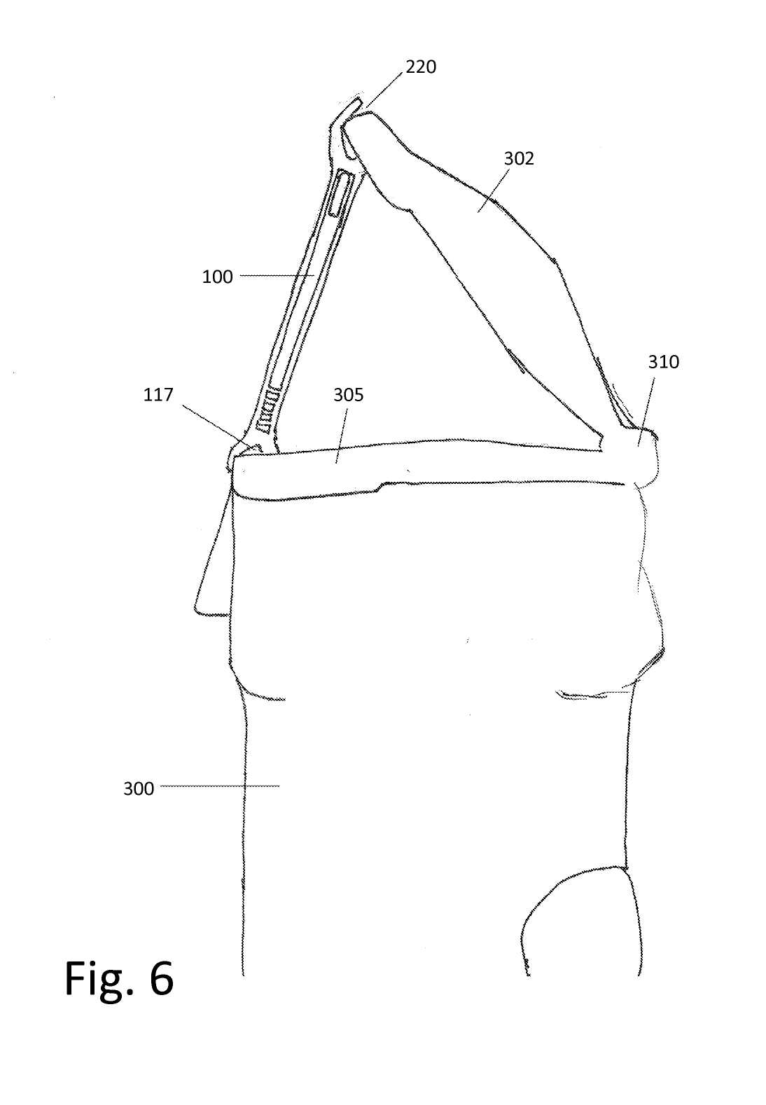

Moving on to FIG. 5, the method of using the tool 100 may continue by engaging the lid 302 with the lid receptacle 220. As shown, the lid receptacle 220 contacts a bottom surface of the lid 302 and a front surface of the lid 302. The lid 302 can rotate away from the base 300 about a hinge 310. The method can continue in FIG. 6 by securing the rim receptacle 117 to a front rim 305 of the base 300. In this way, the lid 302 is secured in the open position away from the base 300. After use, the tool 100 may be removed.

Of course, it is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, certain features of the tool disclosed in the various embodiments can be switched, duplicated, and/or omitted. In addition to the variations described herein, other known equivalents for each feature can be mixed and matched by one of ordinary skill in this art to construct tools in accordance with principles of the present invention.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

1. A method for opening and securing a trash can lid in an open position comprising
a. Grasping a securing tool at a grip area
i. Said securing tool comprising an elongate body having a first end and second end
1. Wherein said first end comprises said grip area disposed adjacent to a pair of substantially parallel protrusions from said first end, said pair of substantially parallel protrusions defining a rim receptacle;
2. Wherein said second end comprises a pair of substantially parallel protrusions defining a lid receptacle
a. Wherein one of said substantially parallel protrusions defining said lid receptacle comprises a wedge section adjacent to said elongate body, said wedge section tapering to a slide section;
b. Engaging the underside of a lid of a of a trash container with said slide section of said lid receptacle of said securing tool;
c. Sliding said slide section fully underneath said lid of said trash container
d. Engaging said underside of said lid with said wedge section of said lid receptacle of said securing tool;
e. Applying a rotational force to said securing tool, pivoting said wedge further underneath said lid and lifting said lid upwards and away from the base of said trash container;
f. Applying a vertical force upward on said lid with said securing tool;
g. Placing said rim receptacle of said securing tool over the rim of said base of said trash container, disposing said rim of said base of said trash container between said pair of substantially parallel protrusions of said rim receptacle; and
h. Releasing said grip area of said securing tool, causing said securing tool to maintain said lid of said trash container to remain in a vertical position.

2. The method as in claim 1 further comprising
a. Regrasping said grip area of said securing tool;
b. Applying a vertical force upward on said lid with said securing tool, removing said rim from said rim receptacle of said securing tool;
c. Lowering said securing tool;
d. Placing said lid on said rim of said base of said trash container; and
e. Removing said wedge section and said slide section of said securing tool from underneath of said lid of said trash container.

3. The method as in claim 2
a. Wherein said securing tool further comprises a hook extending from said elongate body of said securing tool, said method further comprising hanging said securing tool on the side of said trash container with said hook when said securing tool is not in use.

4. The method as in claim 2
a. Wherein said securing tool further comprises an opening in said elongate body of said securing tool, said method further comprising hanging said securing tool on a protrusion extending from the side of said trash container by placing said protrusion within said opening of said securing tool when said securing tool is not in use.
